(19) United States
(12) Patent Application Publication
(10) Pub. No.: US 2024/0425734 A1
(43) Pub. Date: Dec. 26, 2024

(54) ADHESIVE FOR DIGITAL INK PRINTED LAMINATES

(71) Applicant: Dow Global Technologies LLC, Midland, MI (US)

(72) Inventors: Yinzhong Guo, Pearland, TX (US); Amira A. Jyawook, Missouri City, TX (US); Kristy Brown, Pearland, TX (US)

(21) Appl. No.: 18/707,219

(22) PCT Filed: Nov. 30, 2022
(86) PCT No.: PCT/US2022/080652

§ 371 Date: May 3, 2024

Related U.S. Application Data
(60) Provisional application No. 63/267,312, filed on Jan. 31, 2022.

(51) Int. Cl. C09J 175/08; C08G 18/12; C08G 18/67

(52) U.S. Cl. CPC C09J 175/08; C08G 18/12; C08G 18/6755

(57) ABSTRACT

A laminating adhesive with improved digital ink lamination properties comprising an isocyanate component and a polyol component. The isocyanate component comprises an isocyanate prepolymer and an aliphatic polyisocyanate. The polyol component comprises a transesterified polyester polyol made from an aromatic polyester polyol and a natural oil. polypropylene glycols. and a phosphate adhesion promotor. The isocyanate prepolymer within the isocyanate component comprises the reacted product of an isocyanate with a polyalkylene glycol polymer. Laminating structures can be made by coating at least part of a substrate with the adhesive and contacting the first substrate with a second.

### FIELD

The current disclosure relates to laminating adhesives, and more specifically to two component laminating adhesives for digital ink printed laminates comprising an isocyanate component and a polyol component where the isocyanate component comprises the reaction product of a modified isocyanate reacted with a polyalkylene glycol, and an aliphatic polyisocyanate; and the polyol component comprises a transesterified polyester polyol made from an aromatic polyester polyol and a natural oil, polypropylene glycols, and a phosphate adhesion promotor.

### BACKGROUND

Digital or inkjet printing enables economical short run print jobs for custom and personalized packaging. Non inkjet printing methods do not allow economical short-run print jobs and thus make economical personalized packaging all but impossible.

A large proportion of packaging is created using polyethylene, polypropylene, polyester, polyamide, or cellophane substrates laminated together using various adhesives. Laminating adhesives are generally classified as either solvent-based, water-based, or solventless.

Solventless laminating adhesives can be applied at high run speeds since no water or organic solvent must be dried from the adhesive upon application. This makes solventless adhesives preferable in applications requiring quick adhesive application such as short run ink jet personalized packaging print jobs.

However, current laminating adhesives are incompatible with digital inks which leads to lower adhesion performance. Thus, laminating adhesives compatible with digital inks, thereby enabling inkjet printing, is an unmet need.

### DETAILED DESCRIPTION

The present disclosure relates to two component solventless adhesive compositions comprising an isocyanate component and a polyol component. The isocyanate component can comprise the reaction product of a modified isocyanate reacted with a polyalkylene glycol, and an aliphatic polyisocyanate. The polyol component can comprise a transesterified polyester polyol made from an aromatic polyester polyol and natural oil, polypropylene glycols, and a phosphate adhesion promotor. A coated film comprising a substrate and a two component solventless adhesive composition disposed on at least a portion of a surface of the substrate is also disclosed. The adhesive disposed on at least a portion of the surface of one side of the substrate can comprise an isocyanate component and a polyol component. The isocyanate component can comprise the reaction product of a modified isocyanate reacted with a polyalkylene glycol, and an aliphatic polyisocyanate. The polyol component can comprise a transesterified polyester polyol made from an aromatic polyester polyol and natural oil, polypropylene glycols, and a phosphate adhesion promotor.

As stated above, the two-component solventless adhesive composition according to this disclosure comprises an isocyanate component and a polyol component.

Isocyanate Component:

The isocyanate component comprises at least one isocyanate. The at least one isocyanate can be selected from the group consisting of an isocyanate prepolymer, an isocyanate monomer, a polyisocyanate (e.g., dimers, trimmers, etc.), and combinations of two or more thereof. As used herein, a “polyisocyanate” is any compound that contains two or more isocyanate groups. The isocyanate prepolymer is the reaction product of reactants comprising at least one isocyanate and at least one polyol. As used herein, the “isocyanate prepolymer” can be a polyisocyanate itself.

The at least one isocyanate comprises a functionality of from 1.5 to 10, or from 1.8 to 5, or from 2 to 3. As used with respect to the isocyanate component, “functionality” refers to the number of hydroxyl reactive sites per molecule. Compounds having isocyanate groups, such as the isocyanate component, may be characterized by the parameter “% NCO,” which is the amount of isocyanate groups by weight based on the weight of the compound. The parameter % NCO is measured by the method of ASTM D 2572-97 (2010). The disclosed isocyanate component has a % NCO of at least 3%, or at least 6%, or at least 10%. Preferably the isocyanate component has a % NCO not to exceed 25%, or 18%, or 14%.

Further, the at least one isocyanate comprises a free monomer content of from 0 to 50%, from 5 to 40%, or from 10 to 30%. Still further, the at least one isocyanate comprises an average molecular weight of from 200 to 6,000 g/mol, or from 500 to 5,000 g/mol, or from 1000 to 4,000 g/mol. Even further, the isocyanate component has viscosity at 25° C. of from 300 to 40,000 mPa-s, or from 500 to 20,000 mPa-s, or from 1,000 to 10,000 mPa-s, as measured by the method of ASTM D2196.

The isocyanate of the isocyanate component can be an aromatic isomer of methylene diphenyl diisocyanate (“MDI”), such as, but not limited to, 4-4-MDI, 2,2-MDI, 2,4-MDI, and toluene diisocyanate (TDI). As used herein an aromatic isocyanate is an isocyanate that contains one or more aromatic rings.

The amount of the at least one isocyanate in the adhesive composition is, by weight, based on the weight of the adhesive composition (i.e., the total weight of the isocyanate component and the polyol component), at least 5 wt %, or at least 10 wt %, or at least 20 wt %. The amount of the at least one isocyanate in the adhesive composition is, by weight, based on the weight of the adhesive composition, not to exceed 100 wt %, or not to exceed 75 wt %, or not to exceed 50 wt %.

The isocyanate component can also contain a polyalkylene glycol reacted with an isocyanate with NCO terminating groups. As used here a polyalkylene glycol can be, but is not limited to, a polypropylene glycol, a polyethylene glycol, a or an ethylene/propylene copolymer glycol. The isocyanate component can also contain aliphatic polyisocyanates. The amount of aliphatic polyisocyanate is from 0.1 to 10 or 0.1 to 5 weight percent, based on the weight of the isocyanate component. Aliphatic polyisocyanate, as used herein, is an isocyanate that contains no aromatic rings. Examples of aliphatic polyisocyanates disclosed as suitable for use include, but are not limited to, isomers of hexamethylene diisocyanate (“HDI”), propane diisocyanate, butane diisocyanate, pentane diisocyanate, hexane diisocyanate, heptane diisocyanate, octane diisocyanate, nonane diisocyanate, nonane triisocyanate, cycloaliphatic polyisocyanates, or their blends.

Polyol Component:

The polyol component can comprise an aromatic polyester polyol transesterified with a natural oil. The natural oil can be, but is not limited to, castor oil, hydrolyzed epoxidized soybean oil, hydrolyzed epoxidized linseed oil, or mixtures of these. The transesterified aromatic polyester polyol can have an equivalent weight from 100 to 600 g/mol. Commercially available examples of the transesterified aromatic polyester polyol suitable for use according to this disclosure include, but are not limited to, products sold under the trade name MOR-FREE™ C-156 available from the Dow Chemical Company. The polyol component can also include a phosphate adhesion promotor such as MOR-FREE™ 88-138.

The content of the transesterified aromatic polyester polyol can be 5 to 50% by weight, or from 10-40%, or 20 to 35%; the content of the polypropylene glycol can be 40 to 80%, or 50 to 70%, or 55 to 65%; the phosphate ester adhesion promoter can be 0.1 to 20%, or 1 to 15%, or 5 to 10% in the total polyol component.

The process for making the two-component solventless laminating adhesive composition of the present disclosure can include mixing, admixing, or blending an isocyanate component and a polyol component. The isocyanate component can comprise the reacted product of a modified isocyanate with a polyalkylene glycol, and an aliphatic polyisocyanate. The polyol component can comprise a transesterified polyester polyol made from an aromatic polyester polyol and natural oil, polypropylene glycols, and a phosphate adhesion promotor.

The adhesive formulation components may be mixed together by any known mixing process and equipment. The isocyanate component and the polyol component can be prepared and stored separately from one another as is known in the art. The components can be mixed with one another during or immediately prior to application.

The method for forming a laminate structure using the two-component solventless adhesive composition of the present disclosure can comprise the steps of: (1) applying a layer of the adhesive composition to a surface of a first substrate, (2) bringing the layer of the adhesive into contact with a surface of a second substrate to form a laminate structure by a laminator, and (3) curing the adhesive composition to bond the surfaces of the first and second substrates together at ambient temperature or elevated temperature if necessary.

Presently disclosed is a method for forming a laminate structure. In the presently disclosed method, an isocyanate component can be mixed with a polyol component. The isocyanate component can comprise the reacted product of a modified isocyanate with a polyalkylene glycol polyol or a mixture of more than one polyalkylene glycol, and an aliphatic polyisocyanate. The polyol component can comprise a transesterified polyester polyol made from an aromatic polyester polyol and natural oil, polypropylene glycols, and a phosphate adhesion promotor.

The laminate adhesive thus formed can be applied to at least a part of a surface of at least one substrate which can then be brought into contact with the surface of at least one second substrate forming a laminate structure by a laminator. The adhesive composition can then be cured and bond the substrates together.

The two-component solventless laminating adhesive composition presently disclosed can be in a liquid or semi-solid state at 25° C. If in a semi-solid state at 25° C. the presently disclosed solventless laminating adhesive can be heated until the solventless laminating adhesive is in a liquid state. A layer of the mixed adhesive composition can be applied to a surface of a first substrate such as a polymer film. A “film” is any structure that is 2 millimeter (mm) or less in one dimension and is 1 centimeter (cm) or more in both of the other two dimensions. A polymer film is a film that is made of a single polymer or mixture of two or more polymers. Additionally, the film can be metalized polymer films and foils. The weight ratio of the isocyanate component to the polyol component in the curable adhesive mixture can be from 1:1.5 to 2:1, and the NCO index can be from 1.6 to 1.

A surface of a second substrate or film can be brought into contact with the layer of the curable adhesive mixture on the first substrate, prior to curing the adhesive, to form an uncured laminate. The uncured laminate may be subjected to pressure, for example by passing through nip rollers, which may or may not be heated. The uncured laminate may be heated to speed the cure reaction.

Suitable substrates (e.g., first and second substrates) for use according to this disclosure include, but are not limited to, films such as paper, woven and nonwoven fabric, metal foil, polymer films, and metal-coated polymer films. Films optionally have a surface on which an image is printed with ink; the ink may be in contact with the adhesive composition.

The laminates may be double substrates bonded together, may be triple substrates bonded together, or may be multiple substrates bonded together with the adhesive.

Generally, the bonding of the substrates using the solventless laminating adhesive composition of the present disclosure can be carried out in an industrial scale for production of large quantities of lamination products. Advantageously, the two components are filled and stored in separate containers, such as drums or hob bocks, until the components are ready to be used. As aforementioned, prior to the application of the adhesive composition, the two components are stored separately; and only during or immediately prior to the application of the adhesive are the two components mixed with one another. During application, the components are forced out of the storage containers by means of feed pumps, and metered into, via feed lines, a mixing apparatus, such as those commonly used for mixing two-component adhesives in industrial production. For example, the mixing of the two components can be done via static mixers or by means of dynamic mixers. When mixing the two components, care is taken to ensure that the two components are homogeneously mixed insofar as possible. If the two components are poorly mixed, there will be local deviations from the advantageous mixing ratio, which may have implications with respect to a deterioration of the mechanical properties of the resulting product made using the adhesive. In order to check the mixing quality visually it may be advantageous if the two components have two different colors. Good mixing is deemed to exist when the mixed adhesive has a homogeneous mixed color without visible streaks or smears. Controlling and maintaining the mixing ratio of the two components is preferable to achieve a desirable target performance of the adhesive.

The two-component polyurethane adhesive of the present disclosure can be used for all classes of laminates including, for example: laminated film-to-film or film-to-foil composites or film to papers; and the adhesive can be used in packaging applications requiring three performance levels: “general-purpose”, “medium-performance”, and “high-performance” laminates. Typically, the final package product and its filling process determines the type of adhesive material used in the various applications. For instance, general-purpose laminates comprise film-to-film or film-to-paper composites and are typically used to pack dry foods stored at room temperature. Medium-performance laminates are typically used in fatty or acid food packaging, temperature treatments up to pasteurization temperatures, and on foils. High-performance laminates are typically used for boil-in bag applications, hot fillings, sterilization processes at elevated temperatures such as up to 140° C., pharmaceuticals, and the like.

### EXAMPLES

All raw materials and the digital ink printed films are listed in Table 1.

TABLE 1
Raw Materials Used in the Examples:

| Material Name | Supplier | Characteristic |
|---|---|---|
| ISONATE ™ 143L | The Dow Chemical | Liquid MDI |
| | Company | |
| ISONATE 125M | The Dow Chemical | Solid MDI |
| | Company | |
| VORANOL ™ 232-034N | The Dow Chemical | Polypropylene glycol |
| | Company | |
| MOR-FREE ™ L75-197 | The Dow Chemical | MDI prepolymer |
| | Company | |
| CR-5 ™ | The Dow Chemical | Coreactant, blend polypropylene |
| | Company | glycol |
| VORANOL ™ CP-1055 | The Dow Chemical | Glycerine initiated propoxylated |
| | Company | polyether triol |
| MOR-FREE ™ 88-138 | The Dow Chemical | Adhesion promoter |
| | Company | |
| CR-89 ™ | The Dow Chemical | Coreactant, blend polyether |
| | Company | polyols |
| PACACEL ™ L75-191 | The Dow Chemical | MDI prepolymer |
| | Company | |
| CR 88-141 | The Dow Chemical | Coreactant, blend polyester |
| | Company | polyol and polyether polyol |
| MOR-FREE ™ L75-164 | The Dow Chemical | MDI prepolymer |
| | Company | |
| C-411 | The Dow Chemical | Coreactant, blend polyester |
| | Company | polyol and polyether polyol |
| Aromatic Polyester | | Transesterified polyester polyols |
| C-33 | The Dow Chemical | Aliphatic isocyanate (HDI |
| | Company | trimer) |
| Digital Printed 60 g | Kodak, NAA | PP Film |
| BOPP | | |
| 1,5 mil linear low density | Berry Plastics Corp | PE Film |
| Polyethylene(GF-19) | | |
| Digital printed 48 g PET | Kodak, NAA | polyethylene terephthalate Film |
| 2.25 mil EVOH coex | Supplied by TC | EVOH coex LLDPE Film |
| LLDPE | Transcontinental from | |
| | Charter | |
| 48 g PET | FilmQuest | polyethylene terephthalate Film |

Prepolymer 1:

The formulation for Prepolymer 1 is shown in Table 2 below. Prepolymer 1 is prepared by first purging a dried 2L triple-mouth flask connected to a condenser, an overhead mixer, a thermocouple temperature controller, and a nitrogen bubbler of nitrogen. The ISONATE™ 125M and ISONATE™ 143L are then charged in a reactor pre-warmed to 45° C. after which the VORANOL™ 232-034N and VORANOL CP-1055 polyols are loaded. After nitrogen is then continually bubbled through the system for at least two minutes the reactor is gradually heated to 78° C. After the reactor temperature has been maintained at 78° C. for two hours, the reaction is stopped and the product poured into a glass bottle. Prepolymer 1 has an NCO % of 11 by total weight %.

TABLE 2
Composition of the NCO Terminated
Polyurethane Prepolymer:

| | Amount |
|---|---|
| Material | (g) |
| VORANOL ™ CP1055 | 135.5 |
| (polyol) | |
| VORANOL ™ 232-034N | 425.4 |
| (PPG) | |
| ISONATE ™ 125M | 314.6 |
| (solid MDI) | |
| ISONATE ™ 143L | 124.5 |
| (liquid MDI) | |
| Total | 1000.0 |
| Designed NCO % | 11.5 |

Coreactant 1:

Coreactant 1 is prepared by mixing the components in Table 3 using a high-speed mixer at 1,800 rpm for 2 minutes.

TABLE 3
Composition of Coreactant 1:

| | AMT |
|---|---|
| Description | (pbw) |
| MOR-FREE ™ 88-138 | 8.25 |
| Transesterified polyester | 29.29 |
| polyol | |
| VORANOL ™ CP 1055 | 62.46 |
| Total | 100.00 |

Prepolymer 2:

Prepolymer 2 is prepared by mixing Prepolymer 1 with 2% by weight, based on the weight of Prepolymer 1, of C-33 aliphatic polyisocyanate with a high speed mixer at 1,800 rpm for 2 minutes.

Prepolymer 3 is prepared by mixing Prepolymer 1 with 5% by weight of C-33 aliphatic polyisocyanate

Prepolymer 4 is prepared by mixing Prepolymer 1 with 10% by weight of C-33 aliphatic polyisocyanate.

Example 1 in the table below is prepared by reacting Prepolymer 1 with Coreactant 1 at room temperature after mixing, coating, then lamination. Example 2 is prepared by reacting Prepolymer 2 with Coreactant 1 at room temperature after mixing, coating, then lamination. Example 3 is prepared by reacting Prepolymer 3 with Coreactant 1 at room temperature after mixing, coating, then lamination. Example 4 is prepared by reacting Prepolymer 4 with Coreactant 1 at room temperature after mixing, coating, then lamination.

Comparison Example 1 is MOR-FREE™ L75-164/C-411 and Comparison Example 2 is PACACEL™ L75-191/CR 88-141. The NCO % is determined by a titration method according to ASTM D2572-70 at ambient temperature.

Pot life of the two-component polyurethane adhesive of the present disclosure is determined by measuring the viscosity change with curing time with DV II Brookfield Viscometer with spindle 27 at 20rpm running speed at 40° C. The pot life of the adhesive is defined as the curing time of the viscosity reach double of the mixing viscosity or the curing time when the viscosity of the mixed adhesive reach 4000 mPa·s. The mixing viscosity is defined the lowest viscosity of the adhesive after mixing and stabilized at 40° C.

Table 4 shows the mixing viscosity, pot life (curing time of the doubled mixing viscosity) of the adhesives of the present disclosure.

TABLE 4
Pot life of the laminating adhesive Prepolymer 1/Coreactant 1
with different mixing ratios:

| Prepolymer 1/Coreactant 1 mixing ratio | 100/62.6 | 100/67.4 | 100/73.1 |
|---|---|---|---|
| Mixing viscosity (mPa · s) | 1625 | 1575 | 1550 |
| Pot life at double mixing viscosity (min) | 28 | 27 | 27 |
| Pot life at 4000 mPa · s viscosity (min) | 33 | 33 | 33 |

TABLE 5
Pot life of the laminating adhesives:

| | Example | Example | Example | Example | Comparison | Comparison |
|---|---|---|---|---|---|---|
| Sample | 1 | 2 | 3 | 4 | Example 1 | Example 2 |
| Mixing | 1575 | 1600 | 1637 | 1525 | 1400 | 1525 |
| viscosity | | | | | | |
| (mPa · s) | | | | | | |
| Pot life at | 27 | 27 | 27 | 29 | 27 | 28 |
| double | | | | | | |
| mixing | | | | | | |
| viscosity | | | | | | |
| (min) | | | | | | |
| Pot life at | 33 | 33 | 33 | 37 | 39 | 37 |
| 4000 mPa · s | | | | | | |
| viscosity | | | | | | |
| (min) | | | | | | |

As can be seen in example four higher levels of aliphatic polyisocyanate lead to longer curing times with negligible performance increases. The adhesive performance is evaluated through both hand-lamination and pilot-laminator trials with digital ink printed BOPP//GF-19 and digital ink printed PET//EVOH-PE. Hand lamination trials are run at a 27 in/min speed with a hot oil hand laminator in a digital ink printed BOPP//GF-19 structure, a 150° F. nip temperature, and a 40 psi nip pressure. Pilot laminator trials are run on a LABO-COMBI™ 400 laminator, commercially available from Nordmeccanica Group, at 100 ft/min with a digital ink printed PET//EVOH-PE, a 120° F. nip temperature, and a 100° F. metering roll temperature.

T-peel bond strength is measured after 1 day, 6 days, and 14 days of curing on a Thwing-Albert tensile tester with a 200 N loading cell using 1-inch sample strips and a 10inch/min rate. Three strips are tested for each laminate and the high and mean strength are recorded along with the failure mode. For film tear, film stretch, and ink transfer (total or partial ink transfer), the average high value is reported; while for other failure modes (adhesive transfer, adhesion failure and adhesive split) the average mean T-peel bond strength is reported. Typical failure modes included:
AF—Adhesion failure (adhesive on primary).
AT—Adhesive transfer (adhesive on secondary).
AS—Adhesive split (cohesive failure of adhesive).
FT—Film tear (destruct bond).
IT—Total ink transfer.
PIT—Partial ink transfer.

TABLE 6
Bond of Prepolymer 1/Coreactant 1 at different
NCO index in Printed BOPP/GF-19 laminates:
Orange, Pink, Blue different color printed area:

| | | |
|---|---|---|
| NCO Index 1.2 | NCO Ind 1.3 | NCO Ind 1.4 |

1 day bond strength

| | | | |
|---|---|---|---|
| Orange | 276 | 452 | 389 |
| STD | 4 | 58 | 24 |
| Failure | AT, | ink trans/FT | ink trans/FT |
| | no apparent | | |
| | ink trans. | | |
| Pink | 511 | 597 | 560 |
| STD | 48 | 75 | 75 |
| | ink trans/FT | ink trans/FT | ink trans/FT |
| Blue | 609 | 458 | 383 |
| STD | 95 | 26 | 12 |
| | ink trans/Ft | ink trans | ink trans/FT |

6 days bond strength

| | | | |
|---|---|---|---|
| Orange | 275 | 374 | 315 |
| STD | 20 | 45 | 12 |
| Failure | slight PIT | slight, PIT | slight, PIT |
| Pink | 535 | 535 | 481 |
| STD | 21 | 80 | 33 |
| Failure | PIT/FT | PIT/FT | PIT/FT |
| Blue | 493 | 357 | 359 |
| STD | 79 | 8 | 20 |
| Failure | PIT | PIT/FT | PIT |

14 days bond strength

| | | | |
|---|---|---|---|
| Orange | 314 | 310 | not tested |
| STD | 23 | 40 | |
| Failure | slight, PIT | slight, PIT | |
| Pink | 505 | 471 | |
| STD | 12 | 6.2 | |
| Failure | PIT/FT | PIT | |
| Blue | 447 | 374 | |
| STD | 96 | 16 | |
| Failure | PIT/FT | PIT | |

TABLE 7
Bond strength comparison of Example 1 and Example 2
adhesives in Printed BOPP/GF-19 laminates:
Orange, Pink, Blue different color printed area:

| | Example 2 | Example 1 |
|---|---|---|
| Orange | 511 | 374 |
| STD | 69 | 45 |
| Failure | PIT, FT | slight, PIT |
| Pink | 666 | 535 |
| STD | 147 | 80 |
| | PIT, FT | PIT/FT |
| Blue | 376 | 357 |
| STD | 95 | 8 |
| | PIT, FT | PIT/FT |

TABLE 8
Bond strength of Example 2 adhesive comparing the
Comparison Example 2 (PACACEL L75-191/CR 88-141)
in digital printed PET//EVOH-PE structure in different
color printed area:

| | Blue | Black | Orange | White |
|---|---|---|---|---|
| Example 2 | 512 | 522 | 313 | 426 |
| STD | 33 | 4 | 4 | 67 |
| Failure | AS/FT | AS/FT | AS/FT | AS/FT |
| Comparison Example 2 | 185 | 135 | 134 | 307 |
| STD | 35 | 31 | 38 | 42 |
| Failure | AS | AS | PIT | FT |

After curing for 9 days the laminates are heat sealed at 320° F., 40 psi pressure, and 1.0 seconds sealing time. Heat seal resistance is determined by pulling a one-inch-wide strip with a pulling speed of 12 in/min for 1.5 inches. The average of triplicate data is reported below.

TABLE 9
Heat seal resistance comparison of Example 2 adhesive with Comparison Example 1
in digital printed PET//EVOH-PE structure in different color printed area:

| | Heat seal | | | |
|---|---|---|---|---|
| | Blue | Black | Orange | White |
| L75-164/C-411-100/40 | 3949 | 3471 | 3801 | 5077 |
| STD | 299 | 41 | 293 | 670 |
| Failure | PET FT, | delaminate, | delaminate | PET FT, |
| | PE Stress | PE stress | | PE Stress |
| Example 2 | 4369 | 3919 | 3717 | 5106 |
| STD | 56 | 88 | 121 | 419 |
| Failure | whole film | whole film | Delaminate, | PET FT, |
| | snape | snape | PE FT | snape |

PAA decay is tested after samples are cured at 25° C., 50% relative humidity for 2 days and for 3 days by diazotization of the PAAs in the presence of a food-simulant, so that the concentration of PAAs can be determined colorimetricaly. The aromatic amines existing in the test solution are diazotized in a chloride solution, and subsequently coupled with N-(1-naphthyl)-ethylene diamine dihydrochloride, giving a violet solution. An enrichment of the color is done with a fixed phase extraction column. The amount of the PAAs is determined photometrically at a wavelength of 550 nm.

Laminates are prepared as described above. Pouches are formed by cutting a strip of about 30.5 cm×16.5 cm from the middle section of the laminate. Each strip is folded to form a 14 cm×16.3 cm surface area, and heat sealing an edge of about 1 cm along each open longitudinal edge of the folded strip to form a pouch with an inner surface area of 14 cm×14.3 cm. The equipment used for heat sealing the edges is a Brugger HSG-C. Sealing conditions for the laminates are 1.3 to 1.5 bar and 130 to 160° C.

Four pouches (two blanks and two test pouches), each with an inner surface area of about 14.0 cm×14.3 cm, are used for each illustrative film in this study. Each pouch is formed after two days from the time of formation of the respective laminate. Prior to forming a pouch, the laminate is stored at room temperature under ambient atmosphere.

Each pouch is filled with 100 ml of 3% aqueous acetic acid, which is used as the food simulant. The pouches are stored at 70° C. in an air circulation oven for two hours. After cooling the pouches to room temperature, 100 ml of test solution is mixed with 12.5 ml of hydrochloric acid solution (1N) and 2.5 ml of sodium nitrite solution (0.5 g per 100 ml of solution), and the contents are allowed to react for ten minutes. Ammonium sulfamate (5 ml; 2.5 g per 100 ml of aq. solution) is added and allowed to react for ten minutes. A coupling reagent (5 ml; 1 g of N-(1-naphtyl)-ethylenediamine dihydrochloride per 100 g of aq. solution) is added and allowed to react for two hours. After each addition, the resulting mixture is stirred with a glass rod. For the blank pouches, 100 ml of the test solution is mixed with the derivation reagents as discussed above, except for the sodium nitrite.

The solution is concentrated by elution through an ODS solid phase extraction column (ODS reverse phase, C18 end-capped), and the extinction is measured at 550 nm, using a Spectrophotometer Lambda (from Perkin Elmer).

The column is conditioned using, first, 10 ml of methanol, then 10 ml elution solvent, and then 10 ml aqueous hydrochloric acid solution (0.1 N). Each derivatized sample is added to the column using a glass beaker previously rinsed twice with 3 ml of aqueous hydrochloric acid solution (0.1 N). The column is subject to a vacuum (about 2.5 mm Hg) pull, to remove all rinse, for one minute. Then 5 ml of elution solvent is added to the column, and this step is repeated until 10 ml of eluent is collected.

To determine the concentration of PAA, the extinction of the reaction product is measured at 550 nm, in a 5 cm cell, against the reagent blank solution and a series of standards with known concentrations of aniline hydrochloride, which are processed in parallel.

As can be seen in the table below PAA decay is significantly faster in Example 2 than in Comparison Example 1.

TABLE 10
PAA decay comparison of the new adhesive and
MOR-FREE ™ L75-164/C-411:

| | | Comparison Exp 1 |
|---|---|---|
| | | (MOR-FREE ™ |
| Structure | Example 2 | L75-164/C-411) |
| After 2 days curing (ppb) | 0.307 | 4.628 |
| After 3 days curing | 0.198 | 3.560 |

Listing of the claims:

1. A two-component solventless adhesive composition, comprising:
a. at least one isocyanate component comprising an isocyanate prepolymer and an aliphatic polyisocyanate, the isocyanate prepolymer further comprising a reacted product of an isocyanate with a polyalkylene glycol polymer, b. at least one polyol component comprising a transesterified polyester polyol made from an aromatic polyester polyol reacted with a natural oil, polypropylene glycol, and a phosphate adhesion promotor.

2. A coated film, comprising:
a. a substrate;
b. a two component solventless adhesive composition wherein the two component solventless adhesive is disposed on at least a portion of a surface of the substrate and wherein the two component solventless adhesive composition comprises:
i. at least one isocyanate component comprising the a reacted product of an isocyanate with a polyalkylene glycol, and an aliphatic polyisocyanate;
ii. at least one polyol component comprising a transesterified polyester polyol made from an aromatic polyester polyol and easter a natural oil, polypropylene glycol, and a phosphate adhesion promotor.

3. A laminate structure comprising:
a. a first substrate
b. a second substrate
c. a two component solventless adhesive composition wherein the two component solventless adhesive is disposed between the first and second substrate and wherein the two component solventless adhesive composition comprises:
i. at least one isocyanate component comprising an isocyanate prepolymer and an aliphatic polyisocyanate, the isocyanate prepolymer further comprising a reacted product of an isocyanate with a polyalkylene glycol polymer,
ii. at least one polyol component comprising a transesterified polyester polyol made from an aromatic polyester polyol and a natural oil, polypropylene glycol, and a phosphate adhesion promotor.

4. The two component solventless adhesive composition of claim 1, wherein the amount of aliphatic polyisocyanate is from 0.1 to 5 weight percent, based on the weight of the isocyanate component.

5. The two-component solventless adhesive composition of claim 1, wherein the natural oil is castor oil.

6. The laminate structure of claim 3, wherein the bond strength is above 200 g/in.

7. The laminate structure of claim 3, wherein after 3 days of curing the PAA concentration is below 0.200 ppb.

8. The laminate structure of claim 3, wherein the heat seal resistance bond strength is between 3,000 and 6,000 g/in.

9. The two-component solventless adhesive composition of claim 1, wherein the amount of phosphate adhesion promotor is from 0.1 to 20 weight percent, based on the weight of the at least one polyol component.

10. (canceled)

11. The coated film of claim 2, wherein the natural oil is castor oil.

12. The coated film of claim 2, wherein the amount of aliphatic polyisocyanate is from 0.1 to 5 weight percent, based on the weight of the isocyanate component.

13. The coated film of claim 2, wherein the amount of phosphate adhesion promotor is from 0.1 to 20 weight percent, based on the weight of the at least one polyol component.

14. The laminate structure of claim 3, wherein the natural oil is castor oil.

15. The laminate structure of claim 3, wherein the amount of phosphate adhesion promotor is from 0.1 to 20 weight percent, based on the weight of the at least one polyol component.
